(19) United States
(12) Patent Application Publication
(10) Pub. No.: US 2010/0102150 A1
(43) Pub. Date: Apr. 29, 2010

(54) PULVERIZED MATERIAL PRODUCING SYSTEM

(75) Inventors: Hiroshi Maeda, Hyogo (JP); Taiji Maeda, Hyogo (JP)

Correspondence Address: HAMRE, SCHUMANN, MUELLER & LARSON, P.C., P.O. BOX 2902, MINNEAPOLIS, MN, 55402-0902, US

(73) Assignee: EARTH LINK CO., LTD., Akashi-shi, Hyogo (JP)

(21) Appl. No.: 12/441,314

(22) PCT Filed: Sep. 7, 2007
(86) PCT No.: PCT/JP2007/067510

§ 371 Date: Mar. 13, 2009

(30) Foreign Application Priority Data
Sep. 15, 2006 (JP) 2006-251612

(51) Int. Cl. B02C 23/24; B02C 13/08; B02C 17/16; B02C 23/28; B02C 23/32

(52) U.S. Cl. 241/18; 241/17; 241/19; 241/52; 241/56; 241/65; 241/43

(57) ABSTRACT

A pulverized material producing system capable of producing a pulverized material dried sufficiently from a raw material, while at the same time suppressing production costs, even in the case where the raw material has a high moisture content and viscosity, is provided. A pulverized material producing system that includes a pulverizer 2, a container 3, and a heated air supplier 4 that supplies heated air is used. The container 3 includes a first inlet 10, second inlets 11a and 11b, a first outlet 12, and a second outlet 13, and is configured so that a swirl flow 35 is created within the container. The heated air is supplied by the heated air supplier 4 to the interior of the container 3 via the second inlets 11a and 11b. The pulverizer 2 includes a casing 20 provided with a suction port 22 and a discharge port 23, an impeller, and a screen 24 that has many pores, and has blower functionality. The first inlet 10 is connected to the discharge port 23 of the casing via a pipeline 7, and the first outlet 12 is connected to the suction port 22 of the casing via a pipeline 8.

### TECHNICAL FIELD

The present invention relates to a pulverized material producing system that produces pulverized materials for food products, medical products, cosmetics, resins, inorganic substances, and so on.

### BACKGROUND ART

Conventionally, pulverized materials have been used in a variety of areas, such as food products, medical products, cosmetics, and so on. Generally, when producing a pulverized material using a material with a high moisture content and viscosity as the raw material, such as with food products, the raw material first is dried sufficiently using a drier, and the dried raw material then is pulverized using a pulverizer. The reason for this is that if a material with a high moisture content and viscosity is loaded into the pulverizer as-is, the pulverizer will become clogged due to the low flowability caused by the viscosity.

Meanwhile, because the drying process and the pulverizing process are performed separately in batches, it is necessary to perform operations for taking out the raw material from the drier, transporting the dried material to the pulverizer, and furthermore loading the transported raw material into the pulverizer. Because it is necessary to perform these operations by hand or using another separate device, there is a problem in that it is difficult to reduce the production costs involved with the production of the pulverized material.

A system that includes a vortex-type pulverizer and a pneumatic conveying drier has been proposed in order to solve the stated problem (for example, see Patent Document 1). According to the system of Patent Document 1, the vortex-type pulverizer includes a fan on the entrance side of the pulverizing chamber for drawing the raw material into the pulverizing chamber. The discharge port of the vortex-type pulverizer and the inlet of the pneumatic conveying drier are connected by a pipeline.

According to this configuration, the raw material is fed into the pulverizing chamber along with the airflow created by the fan, and moves along with that airflow in the interior of the pulverizing chamber; thus the flowability of the pulverized particles is secured, thereby suppressing clogs in the pulverizer, even if the raw material contains moisture. Furthermore, the pulverized raw materials (pulverized particles) are fed to the pneumatic conveying drier along with the airflow created by the fan via the pipeline, where they come into contact with heated air. Such a system as disclosed in Patent Document 1 performs the pulverizing and drying processes in series, and thus can reduce production costs.

### Patent Document 1: JP 2005-333955A

### DISCLOSURE OF INVENTION

However, even if a pulverized material is to be produced according to the system disclosed in Patent Document 1, the pulverizing process is carried out prior to the drying process, and thus there is a limit to the moisture content of the raw material to be used. With the system disclosed in Patent Document 1, there is no problem when the raw material used is rice with a moisture content of 28% to 34%, but it is difficult to use materials with a moisture content higher than that, such as raw fish, seaweed, bean curd refuse, and vegetables, as the raw material.

Based on the system disclosed in Patent Document 1, a system in which the exhaust port of the pneumatic conveying drier and the suction port of the vortex-type pulverizer are connected by a pipeline and the pulverizing process is performed after the drying process can be considered. In such a system, the raw material is dried, after which the raw material is pulverized.

However, because pneumatic conveying driers dry raw materials by causing those materials to pass through the interior of the pneumatic conveying drier itself along with heated air, it is necessary for the overall length of the drier to be long so that raw materials with a high moisture content can be dried sufficiently. Thus, employing such a system increases the size of the device, which in turn leads to a rise in production costs.

It is an object of the present invention to solve the above-mentioned problems by providing a pulverized material producing system capable of producing a pulverized material having a sufficiently dried raw material, while at the same time suppressing production costs, even in the case where a material having a high moisture content and viscosity is used as the raw material.

In order to achieve the abovementioned object, the pulverized material producing system of the present invention comprises a pulverizer that pulverizes a raw material, a container, and a heated air supplier that supplies heated air into the container. The container includes a first inlet, a second inlet, a first outlet, and a second outlet, each of which communicates with the interior of the container. The heated air supplier supplies the air to the interior of the container via the second inlet; the pulverizer includes a blowing function, and using the blowing function, draws the raw material along with a fluid through a suction port and discharges the pulverized raw material along with the fluid through a discharge port; and the first inlet of the container is connected to the discharge port of the pulverizer via a pipeline, and the first outlet of the container is connected to the suction port of the pulverizer via a pipeline.

As described above, the pulverized material producing system of the present invention is provided with a circuit, and a raw material is circulated through this circuit by the airflow created by the pulverizer and the air (heated air) from the heated air supplier. At this time, the surface area of the raw material, which has been pulverized many times, increases, and thus the evaporation of the moisture contained in the raw material is promoted quickly. The pulverized material producing system of the present invention therefore is capable of reliably and efficiently drying a raw material even in the case where that raw material has a high moisture content. Furthermore, at this time, the heated air used for drying is circulated through the circuit; therefore, the pulverized material producing system of the present invention provides improved energy efficiency, and thus also can realize a reduction in production costs.

### BRIEF DESCRIPTION OF DRAWINGS

FIG. 1 is a structural diagram schematically illustrating the overall configuration of a pulverized material producing system according to Embodiment 1 of the present invention.

FIG. 2 includes diagrams illustrating a pulverizer shown in FIG. 1;

FIG. 2A is a cross-sectional view, FIG. 2B is an external perspective view, and

FIG. 2C is a perspective view illustrating the interior of a casing.

FIG. 3 is a cross-sectional view illustrating the specific configuration of a container illustrated in FIG. 1.

FIG. 4 is a cross-sectional view of the container obtained by cutting the container along the cutting line indicated by A-A′ in FIG. 3.

FIG. 5 is a cross-sectional view of the container obtained by cutting the container along the cutting line indicated by B-B′ in FIG. 3.

FIG. 6 is a perspective view illustrating a plate member shown in FIG. 3.

FIG. 7 is a structural diagram roughly illustrating the overall configuration of a pulverized material producing system according to Embodiment 2 of the present invention.

FIG. 8 is a cross-sectional view illustrating the specific configuration of a container illustrated in FIG. 7.

FIG. 9 is a cross-sectional view of the container in the vicinity of a first inlet obtained by cutting the container along the cutting line indicated by C-C′ in FIG. 8.

FIG. 10 is a cross-sectional view of the container in the vicinity of a second inlet obtained by cutting the container along the cutting line indicated by D-D′ in FIG. 8.

FIG. 11 is a cross-sectional view of the container in the vicinity of a first outlet obtained by cutting the container along the cutting line indicated by E-E′ in FIG. 8.

FIG. 12 is a cross-sectional view illustrating a close-up of part of the cylinder of which the container shown in FIG. 8 is configured.

FIG. 13 is a cross-sectional view illustrating another example of a container that can be used in Embodiment 2 of the present invention.

FIG. 14 is a cross-sectional view illustrating the detailed configuration of a container used in a pulverized material producing system according to Embodiment 3 of the present invention.

FIG. 15 includes diagrams illustrating a plate member shown in FIG. 14; FIG. 15A is a perspective view, and FIG. 15B is a plan view.

FIG. 16 is a structural diagram schematically illustrating the overall configuration of a pulverized material producing system according to Embodiment 4 of the present invention.

FIG. 17 is a structural diagram schematically illustrating another example of the overall configuration of a pulverized material producing system according to Embodiment 4 of the present invention.

FIG. 18 is a structural diagram schematically illustrating the overall configuration of a pulverized material producing system according to Embodiment 5 of the present invention.

### EXPLANATIONS OF REFERENCE NUMERALS

1 pulverized material producing system
2 pulverizer
3 container
3a container inner wall surface
4 heated air supplier
5 air heater
6 blower
7, 8 pipeline
9 raw material feeder
10 first inlet
11a, 11b second inlet
12 first outlet
13 second outlet
14 collector
15 cyclone separator
16 blower
17 finished product (pulverized material)
18, 19 valve
20 casing
21 impeller
22 suction port
23 discharge port
24 screen
24a pore
25 electric motor
30 plate member
31 main body member
31a opening portion
31b through-hole
32 rectifying member
33 support member
34 stay
35 swirl flow
36 plate member
37 projection portion
37a tip portion
37b trunk portion
38 through-hole
39 circular flow channel
40 container
41 first inlet
42a, 42b, 42c second inlet
43 first outlet
44 second outlet
45 raw material feed port
46 screen
46a through-hole
47 rectifying plate
48 swirl flow
49 partition plate
50 pulverized material producing system
51 raw material trajectory
52 circular member
53 opening portion
54 sloped surface
55 nozzle
60 pulverized material producing system
61 container
61a inner wall surface
62 suction pipe
63 swirl flow (descending swirl flow)
70 pulverized material producing sytem
71 container
72 pulverizer
73, 74 pipeline
75 third outlet
76 third inlet

### DESCRIPTION OF THE INVENTION

The pulverized material producing system of the present invention comprises a pulverizer that pulverizes a raw material, a container, and a heated air supplier that supplies heated air into the container. The container includes a first inlet, a second inlet, a first outlet, and a second outlet, each of which communicates with the interior of the container; the heated air supplier supplies the air to the interior of the container via the second inlet; the pulverizer includes a blowing function, and using the blowing function, draws the raw material along with a fluid through a suction port and discharges the pulverized raw material along with the fluid through a discharge port; and the first inlet of the container is connected to the discharge port of the pulverizer via a pipeline, and the first outlet of the container is connected to the suction port of the pulverizer via a pipeline.

Through the abovementioned features, the pulverized material producing system of the present invention sufficiently can dry a raw material without using a large drying device, even if the raw material has a high moisture content. The material, which has been pulverized, its moisture removed, and which now is small and light (that is, the pulverized material), is discharged from the second outlet to the outside of the system, and then is collected. And also, because the pulverized material producing system of the present invention can pulverize the raw material many times using the circuit, the material can be formed to be a powder.

In the pulverized material producing system according to the present invention, it is preferable for the pulverizer to include a casing provided with a suction port and a discharge port, an impeller that is disposed within the casing and that draws a fluid through the suction port and discharges the fluid through the discharge port, and a screen that has many pores and that is disposed so as to collide with the fluid.

The stated pulverized material producing system according to the present invention may have an aspect (a first aspect) in which the container has a cylindrical shape, and is formed so as to be capable of being installed in a state in which the lengthwise direction of the cylinder is parallel to the vertical direction, and, when the container is installed in a state in which the lengthwise direction of the cylinder is parallel to the vertical direction, the second outlet is provided above the first outlet; the second inlet is provided so that the air flows from the bottom to the top within the container. The first inlet is provided so that the fluid introduced into the container therefrom swirls along the inner wall surface of the container, and the first outlet is provided along the tangential direction of the fluid that is swirling.

According to the above first aspect, the blower functionality of the pulverizer makes it possible to create a swirl flow within the container reliably. In addition, material that has been dried and pulverized sufficiently experiences a different centrifugal force from the swirling than material that has not been dried and pulverized sufficiently, and thus the two can be separated; according to the above first aspect, using this fact makes it easy to collect only the material that has been dried and pulverized sufficiently.

In the above first aspect, it is preferable for a plate member to be disposed within the container above the second inlet so as to cover the interior of the container; and for the plate member to include a main body member provided with an opening portion in its center and provided with a plurality of through-holes in the periphery of the opening portion, and a rectifying member that is disposed above the opening portion and that directs the air that has passed through the opening portion toward the inner wall surface of the container.

When such a plate member is provided, heavier material (including pulverized material) drops onto the plate. Furthermore, some of the heated air sent from below the container collides with the rectifying member and changes direction, advancing out radially in the direction of the inner wall surface, and then collides with raw material that already has dropped onto the plate or with raw material that is dropping toward the plate. As a result, the raw material that is falling or has fallen blooms out, disperses, and is dried and pulverized, making it possible to suppress raw material loss and increase the drying efficiency.

In addition, in the above first aspect, it is preferable for a plate member to be disposed within the container above the second inlet so as to cover the interior of the container; the plate member to include a projection portion that is provided in its central portion and that projects in the upward direction, and a plurality of through-holes provided in the peripheral portion of the projection portion; and the projection portion to be formed so that its tip has a conical shape and the outline of the cross-section perpendicular to the direction in which it projects is formed in a circular shape. In this case, a swirl flow can be created reliably in the container.

Furthermore, in the above case, it is preferable for the second outlet to be provided in the uppermost portion of the container; a circular member to be provided along the inner wall surface of the container in a position between the second outlet and the plate member; and the first outlet to be provided below the circular member. In this case, pulverized material that has not reached the product stage reliably can be transported to the pulverizer, making it possible to improve the functionality for removing only the pulverized material that has reached the product stage (the classifying functionality).

Furthermore, it is preferable, in the case where a plate member including a projection portion and a circular member are provided, for the second outlet to be provided in the uppermost portion of the container; a suction pipe communicating with the second outlet and extending downward to be provided in the interior of the container; the circular member to be provided along the inner wall surface of the container in a position between the second outlet and the plate member; the first outlet to be provided between the plate member and the circular member; and the first inlet to be provided above the first outlet and between the second outlet and the circular member. In this case, the classifying functionality can be improved further. In addition, because the lower portion of the interior of the container can be set to a higher temperature than the upper portion, this configuration is useful when pulverizing raw materials that require heat treatment.

Furthermore, it is preferable, in the case where a plate member including a projection portion and a circular member are provided, for the pulverized material producing system according to the present invention to further include a second pulverizer in addition to the first pulverizer; the container further to include a third inlet and a third outlet below the circular member; the third inlet of the container to be connected to a discharge port of the second pulverizer via a pipeline, and the third outlet of the container to be connected to a suction port of the second pulverizer via a pipeline; the third outlet to be provided below the first outlet; and the third inlet to be provided below the third outlet and in a position opposite the side surface of the projection portion of the plate member. In this case, two stages of pulverizing are carried out, making it possible to produce an even finer pulverized material.

The stated pulverized material producing system according to the present invention may have an aspect (a second aspect) in which the container has a cylindrical shape, and is formed so as to be capable of being installed in a state in which the lengthwise direction of the cylinder is parallel to the horizontal direction; the raw material is fed to the interior of the contained from a portion that is an end portion on one side of the container when the container is installed in a state in which the lengthwise direction of the cylinder is parallel to the horizontal direction; the second outlet is provided in a position nearer to the central axis of the container than the first outlet; the first inlet is provided so that the fluid introduced into the container therefrom swirls along the inner wall surface of the container; and the first outlet is provided along the tangential direction of the fluid that is swirling.

According to the above second aspect, a swirl flow can be created within the container, in the same manner as with the first aspect. The same effects discussed with respect to the first aspect therefore can be obtained using the above second aspect as well.

In the above second aspect, it is preferable for a second screen that includes a plurality of through-holes to be disposed in the interior of the container so as to be opposite all or part of the inner wall surface of the container; the second screen to include rectifying plates, one for each of the through-holes, that change the flow direction of the gas that passes through the through-holes to the direction that follows the surface direction of the second screen; and the second inlet to be formed in the side surface of the container so that the air is supplied between the inner wall surface of the container and the second screen. In this case, a swirl flow can be created efficiently within the container. In addition, in this case, it is favorable for the first inlet to be provided so that the fluid introduced into the container therefrom swirls along the surface of the screen.

Furthermore, it is favorable for the stated pulverized material producing system according to the present invention to have an aspect in which the second outlet is connected to a collector for collecting the pulverized material.

As another aspect, the present invention provides a pulverized material production method. The pulverized material production method of the present invention includes forming, in a fluid circuit system formed by connecting a suction port and a discharge port of a pulverizer that pulverizes a raw material to an outlet and an inlet respectively of a container, a circulating flow of heated air that circulates through the pulverizer and the container, and forming a swirl flow of heated air in the container; introducing a raw material containing moisture into the circuit system and creating a mixture of the raw material whose drying state has advanced within the circuit system and/or the pulverized material thereof; circulating the mixture in the circuit system using the circulating flow; pulverizing and drying the mixture in the pulverizer; and classifying and drying the mixture in the container using the centrifugal force of the swirl flow and the circulating flow, collecting dried pulverized material of a predetermined size using the classification, and circulating the remaining mixture in the circuit system.

In the pulverized material production method of the present invention, “the drying has progressed” refers to, for example, when the moisture content (weight ratio) is less than that of the moisture-containing raw material that is introduced. With the pulverized material production method of the present invention, raw material may be introduced continuously or intermittently, and thus it is preferable for raw material for which drying has progressed and/or a pulverized material derived therefrom to be present in the circuit system. Additionally, the “mixture” in the present invention includes the raw material and the pulverized material, and further can include integrated combinations of raw material, integrated combinations of pulverized material, or integrated combinations of raw material and pulverized material arising from adhesion, collision, and the like due to differences in the drying state.

The pulverized material production method of the present invention can be performed using a system such as the pulverized material producing system of the present invention, and embodiments thereof shall be described in the following embodiments of the pulverized material producing system of the present invention.

### Embodiment 1

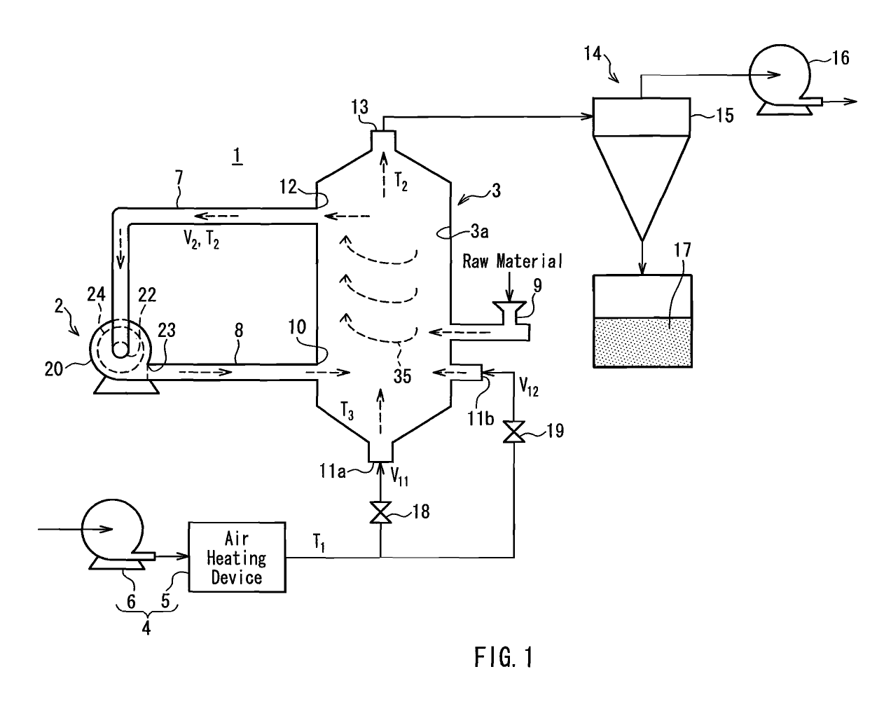

Hereinafter, a pulverized material producing system according to Embodiment 1 of the present invention shall be described with reference to FIGS. 1 through 6. First, the overall configuration of the pulverized material producing system according to Embodiment 1 shall be described using FIG. 1. FIG. 1 is a structural diagram schematically illustrating the overall configuration of a pulverized material producing system according to Embodiment 1 of the present invention.

As shown in FIG. 1, a pulverized material producing system 1 includes a pulverizer 2 that pulverizes a raw material, a container 3, and a heated air supplier 4 that supplies air that has been heated (heated air) to the interior of the container 3. The container 3 includes a first inlet 10, second inlets 11a and lib, a first outlet 12, and a second outlet 13. These inlets and outlets all communicate with the interior of the container 3. The heated air supplier 4 supplies heated air for drying the raw material to the interior of the container 3 via the second inlets 11a and lib.

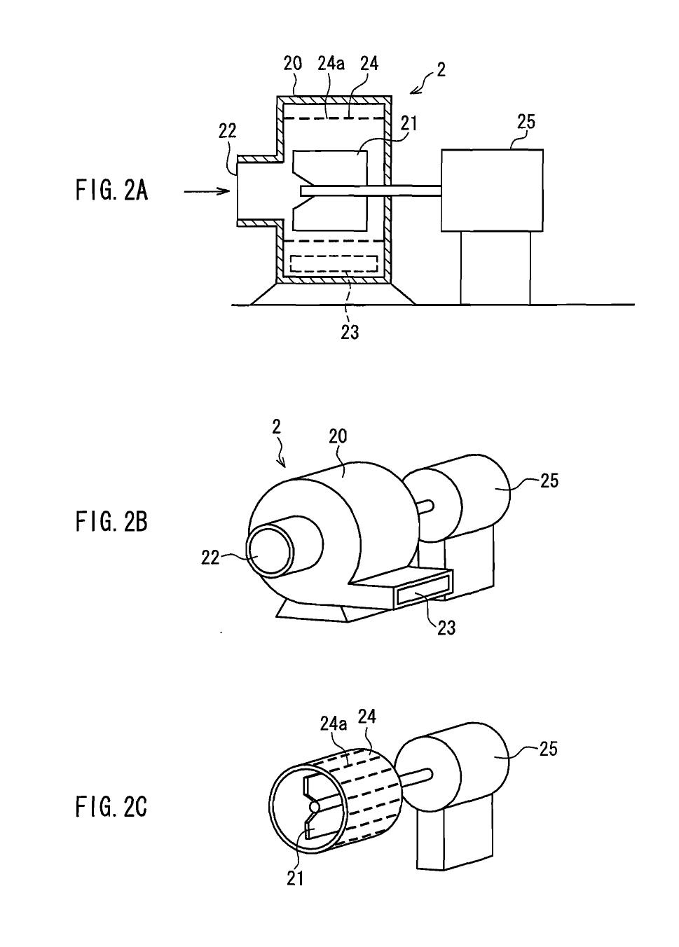

In addition to the functionality for pulverizing the raw material, the pulverizer 2 is provided with a blower functionality. In Embodiment 1, the pulverizer 2 includes an impeller 21 (see FIG. 2), a screen 24 (see FIG. 2), and a casing 20. A suction port 22 and a discharge port 23 are provided in the casing 20 (see FIG. 2). Furthermore, the suction port 22 of the pulverizer 2 and the first outlet 12 are connected by a pipeline 7, and the discharge port 23 of the pulverizer 2 and the first inlet 10 are connected by a pipeline 8. In the pulverized material producing system, a circuit through which a fluid circulates is formed by the pulverizer 2, the container 3, and the pipelines 7 and 8.

Furthermore, in Embodiment 1, the heated air supplier 4 includes a blower 6 and an air heater 5. In the example shown in FIG. 1, the blower 6 is a turbine-type blower, but the blower is not limited thereto; a positive displacement-type blower may be used as well. Additionally, any heating device provided with functionality for heating air sent from the blower 6 may be used as the air heater 5. For example, an electric heater, a burner that uses a flammable gas, kerosene, or the like as its fuel, a steam heater, and the like can be used as the air heater 5. Note that it is favorable for the air heater 5 to be provided with functionality for adjusting the heating temperature.

Meanwhile, the second outlet 13 is used to collect the pulverized material that is to become the finished product, and is provided above the first outlet 12. This is because the pulverized material that is to become the finished product is lighter than the pulverized material that has not yet become the finished product and therefore rises easily. In Embodiment 1, the second outlet 13 is provided in the portion of the container 3 that is the highest portion when the container is installed. In addition, the second outlet 13 is provided in a location nearer to the central axis of the container 3 than the first outlet 12. This is because the centrifugal force applied to the raw material (the pulverized material) by a swirl flow 35, mentioned later, decreases as the raw material is dried and pulverized repeatedly and approaches the product stage, resulting in the raw material (pulverized material) that has reached the product stage swirling near the center of the interior of the container 3.

In addition, the second outlet 13 is connected to a collector 14 that collects the pulverized material that is to be the finished product. The collector 14 includes a cyclone separator 15 and a blower 16 that is used for exhaust. However, the collector 14 is not limited to the example shown in FIG. 1; for example, an electrostatic precipitator, a gas filter such as a bag filter, or the like may be used instead of the cyclone separator 15. Note that 17 indicates the pulverized material that is to be the finished product. Like the blower 6, the blower 16 may be a turbine-type blower or a positive displacement-type blower. Furthermore, the pulverized material producing system of Embodiment 1 may have a configuration that includes only one of the blower 16 and the blower 6.

In Embodiment 1, the raw material used for producing the pulverized material is supplied directly to the interior of the container 3 by a raw material feeder 9. The location to which the raw material is supplied is set to the side surface of the container in a location closer to the bottom of the container than to the top. In addition, as shall be discussed later, the location to which the raw material is supplied also is set so as to approach the source of the fluid introduced through the first inlet 10. Note that the location to which the raw material is supplied is not particularly limited. The raw material may be supplied to the pipeline 7 or 8 or to the container 3.

Next, the pulverizer shown in FIG. 1 shall be described in detail using FIG. 2. FIG. 2 includes diagrams illustrating the pulverizer shown in FIG. 1; FIG. 2A is a cross-sectional view, FIG. 2B is an external perspective view, and FIG. 2C is a perspective view illustrating the interior of the casing. As shown in FIGS. 2A to 2C, the pulverizer 2 includes a casing 20 provided with a suction port 22 and a discharge port 23, as well as an impeller 21 and a screen 24 disposed within the casing 20.

As shown in FIG. 2A, the impeller 21 draws a fluid from the suction port 22 and discharges the substance out the discharge port 23. In Embodiment 1, the axle of the impeller 21 is connected to the axle of an electric motor 25 that drives the impeller 21. Therefore, a high-speed airflow (for example, 15 to 30 m/s) is discharged from the discharge port 23. The number of blades, angle of attachment, and so on of the impeller 21 are not particularly limited.

The screen 24 is a member that includes many pores 24a. The screen 24 is disposed so that the fluid that flows within the casing 20 collides with the screen 24. In Embodiment 1, the screen 24 is made of metal such as stainless steel, and is formed as a cylinder. The screen 24 also is disposed as a concentric circle relative to the axle of the impeller 21, and thus the fluid sent by the impeller 21 absolutely is prevented from reaching the discharge port 23 if it does not first pass through the pores 24a of the screen 24.

With such a configuration, when the impeller 21 is rotated, the raw material supplied from the raw material feeder 9 (see FIG. 1) rises while swirling within the container 3, as shall be described later, due to the wind force generated by the impeller 21. Furthermore, the raw material passes through the pipeline 7 (see FIG. 1) due to the wind force generated by the impeller 21, and is drawn into the casing 20 via the suction port 22 along with air. The raw material then is pulverized as a result of collisions with the inner wall of the pores 24a of the screen 24, impacts from the impeller 21 within the space enclosed by the screen 24, and collision with other raw material. Furthermore, the raw material swirls along the screen 24 due to the rotation of the impeller 21, and is broken down as a result.

In addition, as shown in FIG. 1, the pulverizer 2 is configured so as to form a circuit along with the container 3, and thus raw material that already has been pulverized (pulverized material) once again is drawn into the pulverizer 2. In this case, the pulverized material once again collides with the screen 24 and the impeller 21, collides with other raw material, and so on. The pulverized material therefore is pulverized further and reduced in size due to the pulverizing process being performed again.

Meanwhile, each time the raw material is pulverized, its surface area increases, and thus the surface area that makes contact with the surrounding air also increases. Furthermore, the heat emitted by the pulverizer is transferred to the gas (fluid), and the temperature of the gas thus rises. Due to these two effects, the raw material is pulverized, and at the same time, the drying thereof proceeds quickly. In other words, the drying of the raw material is carried out also in the pulverizer 2, and thus the pulverizer 2 also plays the role of a dryer. However, the drying (moisture removal) resulting from only the heat generated by the pulverizer is insufficient, and thus the remaining necessary heat is supplied by the heated air supplier 4.

Note that in the example shown in FIG. 2, the pulverizer 2 is disposed so that the suction port 22 is facing in the horizontal direction, but the present embodiment is not limited thereto. The pulverizer 2 may be disposed so that the suction port 22 faces upward in the vertical direction. In this case, the electric motor 25 is disposed below the casing 20.

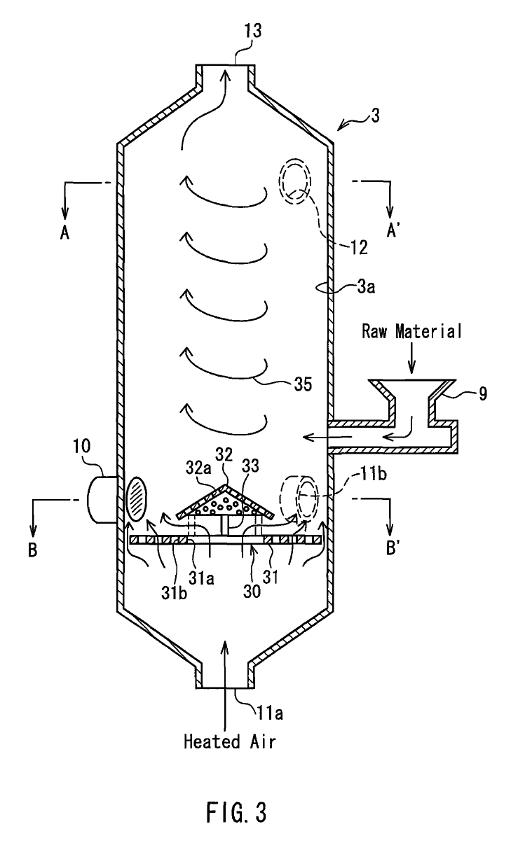

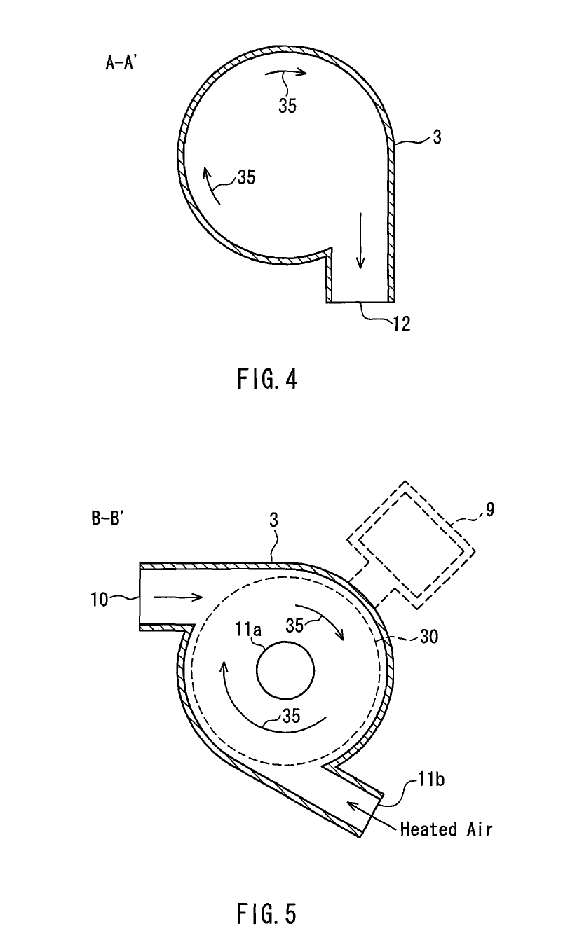

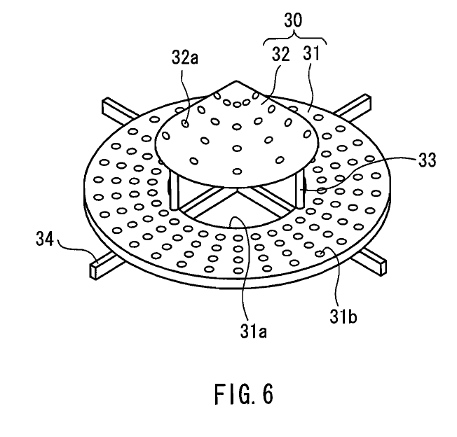

Next, the container 3 shown in FIG. 1 shall be described in detail using FIGS. 3 to 6. FIG. 3 is a cross-sectional view illustrating the specific configuration of the container illustrated in FIG. 1. FIG. 4 is a cross-sectional view of the container obtained by cutting the container along the cutting line indicated by A-A′ in FIG. 3. FIG. 5 is a cross-sectional view of the container obtained by cutting the container along the cutting line indicated by B-B′ in FIG. 3. FIG. 6 is a perspective view illustrating the plate member shown in FIG. 3.

As shown in FIG. 3, in Embodiment 1, the container 3 has a cylindrical shape. Additionally, the container 3 is installed in a state in which the lengthwise dimension of the cylinder is parallel to the vertical direction, and is thus formed so such an installation is possible. In the example of FIG. 3, the container 3 is a cylinder whose cross-section is circular. This is to make it easier to generate the swirl flow 35, which shall be described later.

The first inlet 10 is provided so that the fluid introduced into the container therefrom (in other words, the air containing the pulverized material) swirls along the inner wall surface of the container 3. To be more specific, as shown in FIG. 5, the first inlet 10 is formed in the side surface of the container 3 so that the fluid is introduced into the container 3 along the tangential direction of the cross-section of the container 3. The fluid discharged from the pulverizer 2 (see FIG. 1) therefore swirls along the inner wall surface of the container 3.

The second inlets (second inlets 11a and lib) are disposed in two places, one being in the lowest portion of the container 3 when the container 3 is installed, and the other being in the side surface of the container 3. Heated air is supplied to the interior of the container 3 from the second inlet 11a, from the bottom up.

In addition, as shown in FIG. 5, in Embodiment 1, the second inlet lib is formed in the side surface of the container 3 so that heated air is supplied into the container 3 along the tangential direction of the cross-section of the container 3. The heated air supplied from the second inlet 11b also swirls along the inner wall surface of the container 3, in the same manner as the fluid supplied from the first inlet 10.

Furthermore, as shown in FIG. 4, like the first inlet 10 and the second inlet 11b, the first outlet 12 is formed along the tangential direction of the cross-section of the container 3 (the tangential direction of the swirl flow 35). Therefore, as shown in FIG. 4, the gas inside the container is sucked out through the first outlet 12 while swirling along the inner surface of the container 3. In addition, the first outlet 12 is provided higher than the first inlet 10 and the second inlets 11a and lib.

In this manner, with Embodiment 1, the swirl flow 35 is generated within the container 3 by the discharge of the fluid from the first inlet 10 in the tangential direction, the supply of heated air from the second inlet lib in the tangential direction, and the suction of the fluid from the first outlet 12 in the tangential direction.

Furthermore, a rising flow is generated within the container 3 by the supply of the heated air from the second inlet 11a in the upward direction and the suction by the first outlet 12 at the top of the container 3. The stated swirl flow 35 combines with the upward flow within the container 3, rising within the container 3 while swirling. Note that in Embodiment 1, with respect to the second inlets, it is acceptable for only the second inlet 11a to be provided at the bottom of the container.

Additionally, although centrifugal force is applied to the raw material by the swirl of the swirl flow 35 within the container 3, the larger the mass, or in other words, the less sufficient the pulverizing and drying processes have been, the greater the centrifugal force applied at this time, and thus the swirl occurs closer to the inner wall surface of the container 3. As mentioned above, in Embodiment 1, the first outlet 12 is formed along the tangential direction of the cross-section of the container 3. For this reason, Embodiment 1 efficiently can re-introduce raw material that experiences a large degree of centrifugal force into the pulverizer 2. Raw material that has been re-introduced into the pulverizer 2 then is pulverized, buoyed by the fast airflow, and once again passes through the pipeline 8 and into the container 3.

In addition, as illustrated in FIG. 1, pulverized material whose pulverizing and drying is sufficient and that has reached the product stage experiences little centrifugal force from the swirl flow 35, and therefore proceeds near the center of the container 3; as a result, this pulverized material passes through the second outlet 13 and is collected by the collector 14 (see FIG. 1).

The ratio of heated air that flows in from the second inlet 11a to the heated air that flows in from the second inlet 11b is adjusted using a valve 18 provided upstream of the second inlet 11a (see FIG. 1) and a valve 19 provided upstream of the second inlet 11b (see FIG. 1). Note that the overall amount of heated air supplied is regulated by a damper (not shown) provided in the heated air supplier 4.

Additionally, in Embodiment 1, a plate member 30 is disposed above the second inlet 11a within the container 3 so as to cover the interior of the container 3, as shown in FIG. 3. The plate member 30 is, as shown in FIG. 6, provided with a main body member 31 and a rectifying member 32. The main body member 31 is a plate provided with an opening portion 31a in its center, and multiple through-holes 31b are provided in the periphery of the opening portion 31a of the main body member 31. Furthermore, the plate member 30 is installed using a cross-shaped stay 34. The stay 34 is not shown in FIG. 3, but is attached to the inner wall surface 3a of the container 3.

Meanwhile, the rectifying member 32 is disposed above the opening portion 31a, directing some of the heated air that has passed through the opening portion 31a toward the inner wall surface of the container 3. To be more specific, the rectifying member 32 has a conical shape, with through-holes 32a provided in the cone portion. The rectifying member 32 is kept above the opening portion 31a by support members 33.

Incidentally, a case in which the plate member 30 is not installed and raw material whose heavy weight (high moisture content) makes it difficult to create the swirl flow 35 is supplied to the container 3 can be considered. In this case, the heavy raw material flows at or near the bottom of the container 3 without rising. It then slowly blooms out and dries as a result of contact with heated air. When the drying advances and the raw material reaches a weight that allows it to rise in the swirl flow 35, it rises within the container.

Even if the plate member 30 is provided, heavy raw material cannot rise, and flows on or slightly above the plate member 30 without rising. However, in this case, part of the heated air that has passed through the opening portion 31a collides with the conical rectifying member 32 and changes direction, advancing in a radial direction toward the inner wall surface. The heated air that has thus advanced in a radial direction collides with raw material that has already dropped onto the plate member 30 or with raw material that is flowing on the plate member 30 without rising.

For this reason, providing the plate member 30 results in heavy raw material that cannot rise in the swirl flow 35 blooming out and drying in a shorter time than when the plate member 30 is not provided. Therefore, providing the plate member 30 makes it possible to realize an improvement in drying efficiency over the case where the plate member 30 is not provided. In addition, providing the plate member 30 prevents raw material from attaching to the corners of the container 3 due to some raw material coming into little contact with the heated air.

In Embodiment 1, the plate member 30 is formed so that a space exists between its outer edge and the inner wall surface 3a of the container 3, as shown in FIGS. 3 and 5 (in FIG. 5, only an outline of the plate member 30 is shown, represented by a broken line). This is because failing to provide a space makes it easy for raw material to build up/become attached between the inner wall surface 3a of the container 3 and the upper surface of the plate member. In Embodiment 1, the heated air from the second inlet 11a passes through this space from the bottom to the top, thus preventing the abovementioned build-up and attachment of raw material.

In Embodiment 1, the container 3 is not limited to the example shown in FIGS. 3 through 6. In the example shown in FIGS. 3 through 6, the container 3 has, with the exception of its end portions, a cylindrical shape with a constant radius, but the container 3 may have a conical shape in which the radius increases toward the top of the container. According to this example, the cross-sectional area increases toward the top, and thus the rising speed of the swirl flow 35 slows down. The heavier the pulverized material, whose pulverizing and drying is insufficient, is, the more difficult it is for that pulverized material to rise, and thus it swirls for a longer time. For this reason, according to this configuration, it is easy to separate the pulverized material that is to become a product from the heavy pulverized material whose pulverizing and drying is insufficient.

Note that in the case where the container 3 is placed upright, as shown in FIG. 3, it is favorable for the end portion on the lower side of the container 3 to be formed in a tapered shape. This is to make it easier to collect the pulverized material that has reached the product stage but that has not been collected by the collector 14 and remains in the container 3 after the operation of the system has been stopped.

Next, the state of the interior of the container 3 in the case where raw material is loaded via the raw material feeder 9 when pulverized raw material already is loaded in the container 3 shall be described. In this case, the raw material that has been newly loaded into the container 3 from the raw material feeder 9 first collides with the pulverized material discharged from the first inlet 10 along with the high-speed airflow (the pulverized raw material that is already loaded). Due to this collision, the newly-loaded raw material blooms out. Some of the pulverized material that has collided falls in with the newly-loaded raw material and attaches thereto, becoming a single entity. The pulverized material that has become a single entity has a moisture content less than that of the newly-loaded raw material, and thus absorbs the moisture therefrom (moisture migration between solids).

However, the pulverized material is exposed to heated air while still being attached to the newly-loaded raw material, and thus both are dried while being swirled within the container 3. As the drying advances, the pulverized material that has been attached to the raw material peels off from that raw material, and once again turns into small particles. At this time, the pulverized material has an extremely large surface area relative to its moisture content, and thus dries very quickly. In the case where this dried pulverized material once again attaches to raw material that has a higher moisture content than the pulverized material, the abovementioned peeling off and quick drying is repeated.

In this manner, when new, undried raw material is loaded as the pulverized material circulates, the pulverized material and the new raw material integrate with one another, dry, peel off, and the pulverized material dries quickly. As a result, the drying of the loaded raw material can be accelerated more than when the raw material is loaded when no pulverized material is circulating at all. Thus, it is favorable, in Embodiment 1, for raw material itself or pulverized raw material to be supplied to the container 3 in advance, and raw material with a high moisture content then to be loaded in the container 3 thereafter.

Meanwhile, with the pulverized material producing system of Embodiment 1, the drying of the pulverized material is, as described above, carried out within the pulverizer 2 as well. Furthermore, because the raw material is taken up in the airflow and passes sequentially through the container 3, the pipeline 7, the pulverizer 2, and the pipeline 8, the raw material blooms out due to the airflow even while passing through the pipeline 7 and the pipeline 8, which results in the drying advancing. In this manner, according to Embodiment 1, the raw material can be dried constantly within the circuit, and thus even materials with a high moisture content, which are difficult to pulverize with conventional devices, can be pulverized while carrying out drying to a sufficient degree. Moreover, as opposed to the conventional method of drying and pulverizing in batches, using the pulverized material producing system of Embodiment 1 renders transport operations and the like unnecessary, and furthermore, because it is not necessary to increase the size of the drier, it is also possible to suppress an increase in costs.

In Embodiment 1, the raw material to be pulverized and dried is not particularly limited. In Embodiment 1, this may be a viscous material with a high moisture content (for example, a moisture content of 70% or more). The pulverized material producing system of Embodiment 1 can be applied to a wide range of raw materials. Organic substances, inorganic substances, plant-derived raw materials, animal-derived raw materials, and so on can be given as examples of raw materials. Medicines, wood, bamboo, resins, elastomers, collagen, gelatin, grains, legumes, vegetables, fruits, sludges, and so on can be given as more specific examples of raw materials. Only one type of raw material may be supplied, or two or more types of raw materials may be supplied.

Incidentally, as shown in FIG. 1, the temperature of the heated air supplied by the heated air supplier 4 is T₁[° C.]; the flow rate of the heated air is V₁(=V₁₁+V₁₂)[Nm³/s]; the temperature of the fluid that enters the first outlet 12 and is sent through a second pulverizing process is T₂[° C.]; and the flow rate thereof is V₂[m³/s]. At this time, a temperature T₃[° C.], of the gas at the bottom of the container 3, can be approximately calculated using Equation (1), below. Note that V₁₁ indicates the flow rate [Nm³/s] of the heated air that passes through the inlet 11a, whereas V₁₂ indicates the flow rate [Nm³/s] of the heated air that passes through the inlet 11b. The temperature of the fluid discharged from the second outlet 13 is also approximately T₂[° C.].

(Equation 1) T₃=(T₁×V₁+T₂×V₂)/(V₁+V₂) (1)

The heated air, meanwhile, decreases as it comes into contact with the raw material while rising from the bottom of the container 3 toward the top. Thus, the temperature T₃ is a numerical value that is influenced by the temperature of the raw material during discharge from the second outlet 13, and setting the value of T₃ to an appropriate value is very important in terms of suppressing quality changes in the raw material. For this reason, in Embodiment 1, the values of T₁, V₁, T₂, and V₂ are appropriately set so that T₃ takes on an appropriate value. V₁ can be adjusted using the damper (not shown) provided in the heated air supplier 4 as described above. V₂ can be suppressed with ease based on the number of rotations of the impeller 21 of the pulverizer 2 (see FIG. 2). T₁ and T₂ can be adjusted by adjusting the temperature of the air heater 5.

Hereinafter, a specific example shall be given regarding the temperature T₃[° C.] of the gas at the bottom of the container 3. This case assumes that the temperature T₁ of the heated air is 200[° C.], the temperature T₂ of the fluid that enters the first outlet 12 and is sent through a second pulverizing process is 65[° C.], and the ratio of V₂ to V₁ is 2:1. In this case, the flow rate of the fluid expelled by the pulverizer 2 is twice the flow rate of the heated air expelled by the heated air supplier 4. T₃ takes on the following value.

T₃=(200×1+65×2)/(1+2)=110° C.

In this manner, even if a large amount of heat energy is applied to the heated air and the air is raised to a high temperature, the temperature of the air with which the raw material (including pulverized material) comes into contact drops due to the circulating fluid. Furthermore, in actuality, the heat energy applied to the heated air is consumed for evaporation of the moisture contained in the raw material, and due to this as well, the temperature of the air with which the raw material comes into contact drops. Accordingly, Embodiment 1 makes it possible to suppress a change in the quality of the raw material.

In Embodiment 1, the number of times the raw material circulates (number of circulations) through the pulverized material producing system is not particularly limited. The number of circulations fluctuates depending on the ratio of the flow rate of the flowing substance that passes through the pipelines 7 and 8 to the flow rate of the fluid that passes through the second outlet 13 (a flow rate ratio), the ratio between the percentage of the pulverized material fluid in the vicinity of the second outlet 13 to the percentage of the pulverized material fluid in the vicinity of the first outlet 12 (pulverized material percentage ratio), and so on. In addition, the greater the number of circulations, the smaller the size of the pulverized material becomes.

To be more specific, in the case where the state flow rate ratio is 2, and the pulverized material percentage ratio is 3, the number of circulations of the raw material is approximately 6. Note that the flow rate ratio, the pulverized material percentage ratio, and so on fluctuate depending on the flow rate of the heated air, the size of the pores 24a in the screen 24, the number of rotations of the impeller 21, the amount of raw material loaded, and so on. In addition, by setting these parameters appropriately and changing the flow rate ratio, pulverized material percentage ratio, and so on, the size of the pulverized material in the finished product stage can be set to any value.

Here, the pulverized material obtained using the pulverized material producing system of Embodiment 1 shall be described in detail. Table 1 indicates raw materials and the pulverized material obtained using the pulverized material producing system of Embodiment 1. Note that in Table 1, “fresh basil” refers to unprocessed basil leaves, and the size thereof is expressed as total length and total width (total length×total width). “Rice wine sediment” takes on a plate shape, and the size thereof is expressed as the length of one side of the plate and the thickness (written in parentheses).

TABLE 1

| | Raw Material Data | | | | Product Data | | | |
|---|---|---|---|---|---|---|---|---|
| Raw | Moisture | | | Processed | Moisture | Avg. Particle | Temp. within System | |
| Material | Content | Size | | Amount | Content | Diameter | T₁ | T₂ |
| Raw Bean | 76% | 1-3 | mm | 150 Kg/h | 7.5% | 78 μm | 200° C. | 60° C. |
| Curd | | | | | | | | |
| Refuse (1) | | | | | | | | |
| Raw Bean | 75.8% | 1-3 | mm | 120 Kg/h | 6.2% | 52 μm | 200° C. | 62° C. |
| Curd | | | | | | | | |
| Refuse (2) | | | | | | | | |
| Soy Sauce | 33.2% | 3-7 | mm | 212 Kg/h | 8.2% | 800 μm | 150° C. | 65° C. |
| Sediment | | | | | | | | |
| Fermented | 50% | 3-10 | mm | 180 Kg/h | 11.7% | 1050 μm | 130° C. | 60° C. |
| Fish | | | | | | | | |
| Residue | | | | | | | | |
| Used Green | 76.6% | 2-15 | mm | 106 Kg/h | 7.1% | 136 μm | 210° C. | 70° C. |
| Tea Leaves | | | | | | | | |
| Fresh Basil | 90% | 40 mm × 60 mm | | 60 Kg/h | 8.3% | 48 μm | 150° C. | 65° C. |
| Rice Wine | 42% | 30-50 | mm | 110 Kg/h | 7.4% | 32 μm | 170° C. | 70° C. |
| Sediment | | (3-4 | mm) | | | | | |

As can be seen from Table 1 above, according to the pulverized material producing system of Embodiment 1, a material can be dried, pulverized, and reduced to a dried powder reliably, even if that material is viscous and has a high moisture content.

### Embodiment 2

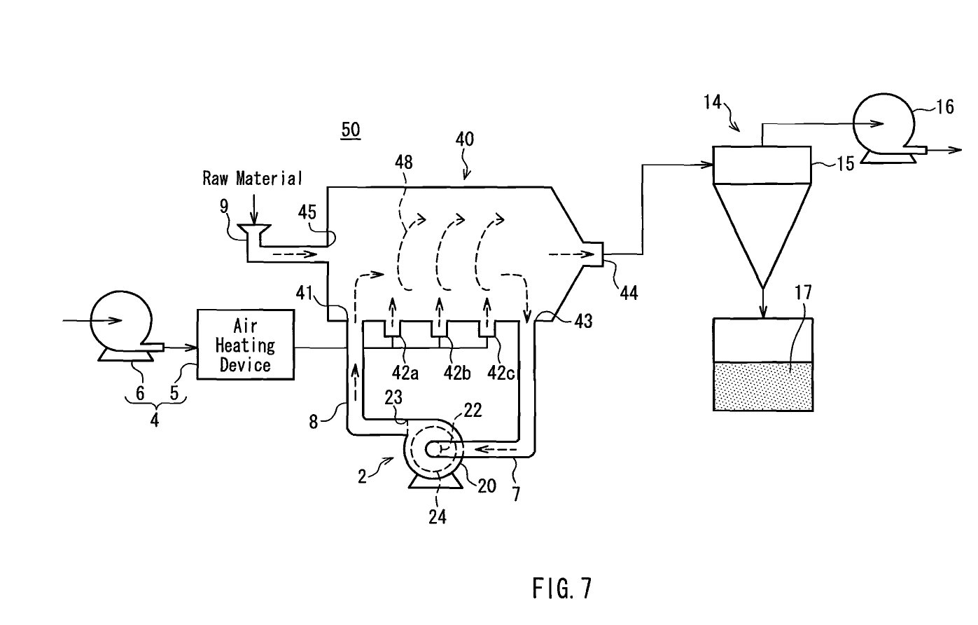

Hereinafter, a pulverized material producing system according to Embodiment 2 of the present invention shall be described with reference to FIGS. 7 through 12. First, the overall configuration of the pulverized material producing system according to Embodiment 2 shall be described using FIG. 7. FIG. 7 is a structural diagram schematically illustrating the overall configuration of a pulverized material producing system according to Embodiment 2 of the present invention.

As shown in FIG. 7, in Embodiment 2, a pulverized material producing system 50 differs from the pulverized material producing system of Embodiment 1 in terms of the structure of a container 40. Aside from that, however, the pulverized material producing system 50 of Embodiment 2 has the same configuration as the pulverized material producing system 1 of Embodiment 1.

The container 40 has, like the container 3 shown in FIGS. 1 and 3, a cylindrical shape whose cross-section is circular. The container 40 also includes a first inlet 41, second inlets 42a to 42c, a first outlet 43, and a second outlet 44. However, in Embodiment 2, the container 40 is installed in a state in which the lengthwise direction of the cylinder is parallel to the horizontal direction, and is formed in such a manner that such a horizontal installation is possible.

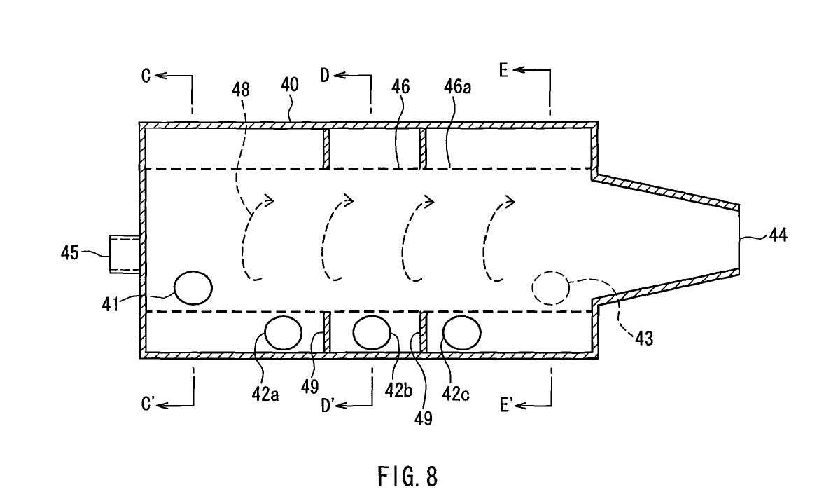

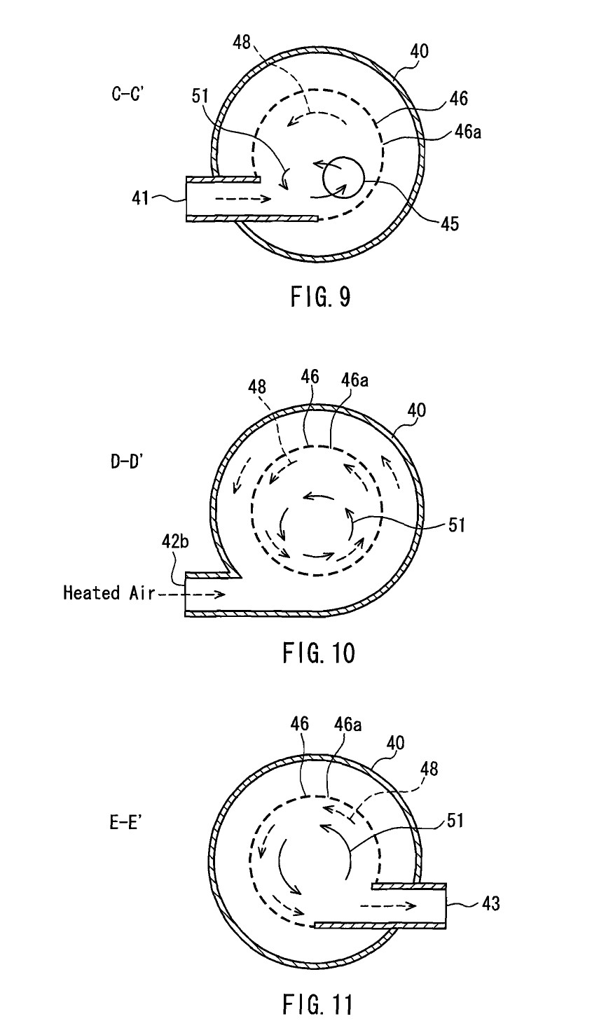

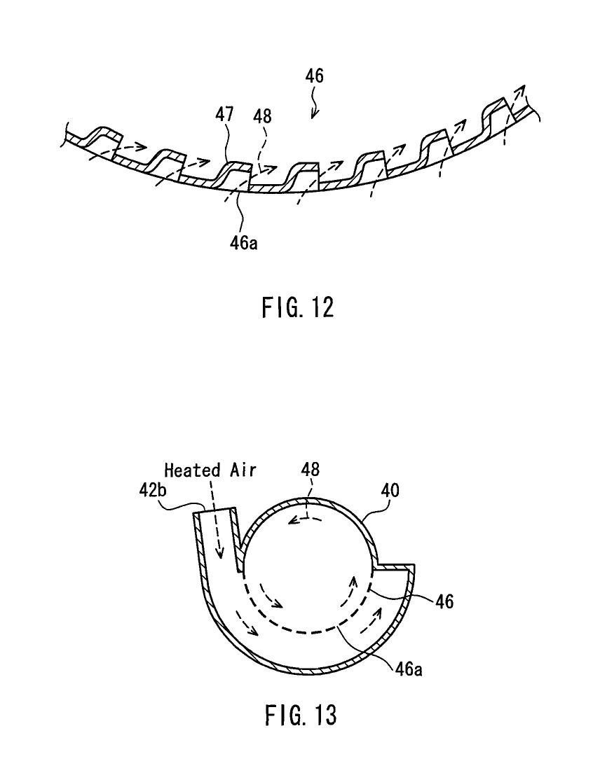

Next, the container 40 shown in FIG. 7 shall be described in detail using FIGS. 8 to 12. FIG. 8 is a cross-sectional view illustrating the specific configuration of the container illustrated in FIG. 7. FIG. 9 is a cross-sectional view of the container in the vicinity of the first inlet obtained by cutting the container along the cutting line indicated by C-C′ in FIG. 8. FIG. 10 is a cross-sectional view of the container in the vicinity of the second inlet obtained by cutting the container along the cutting line indicated by D-D′ in FIG. 8. FIG. 11 is a cross-sectional view of the container in the vicinity of the first outlet obtained by cutting the container along the cutting line indicated by E-E′ in FIG. 8. FIG. 12 is a cross-sectional view illustrating a close-up of part of the cylinder of which the container shown in FIG. 8 is configured.

As shown in FIG. 8, with the pulverized material producing system 50 of Embodiment 2, a raw material is supplied to the interior of the container 40 from what is one end portion on one side of the container 40 when the container 40 is installed on its side. To be more specific, the container 40 is provided with a raw material feed port 45 on the end portion located on the opposite side as the end portion in which the second outlet 44 is provided.

In addition, the second outlet 44 is provided in a location nearer to the lengthwise axis (central axis) of the container 40 than the first outlet 43. To be more specific, the second outlet 44 is provided in the center of what is the other end portion of the container 40 when the container 40 is installed on its side. This is because a swirl flow 48 is created within the container 40, as shall be described later, in Embodiment 2 as well, and thus such a configuration efficiently collects pulverized material in the product stage that is little affected by centrifugal force.

Furthermore, as shown in FIGS. 8 and 10, in Embodiment 2, the second inlets for introducing heated air are provided in three places on the side surface of the container 40 (the second inlets 42a to 42c). However, the number of the second inlets is not particularly limited.

Furthermore, in Embodiment 2, partition plates 49 are disposed between adjacent second inlets (42a to 42c), as shown in FIG. 8. In the example of FIG. 8, the closer to the left side of the diagram, the higher the moisture content of the raw material (including the pulverized material) is, which causes a large drop in the temperature of the heated air; thus, the partition plates 49 are provided, and the temperature within the container 40 is adjusted across multiple zones. Note that the temperature adjustment is performed by adjusting the blowout amount of each of the second inlets 42a to 42c.

In addition, the second inlets 42a to 42c are formed so that the heated air introduced into the container 40 swirls along the inner wall surface of the container 40, or to be more specific, so that the heated air is supplied along the tangential direction of the cross-section of the container 40. Furthermore, in Embodiment 2, a screen 46 including multiple through-holes 46a is disposed within the container 40. In the examples shown in FIGS. 8 through 12, the screen 46 has a cylindrical shape, and opposes the entire inner wall surface of the container 40. By disposing such a screen 46, the swirling properties of the swirl flow 48 can be enhanced.

As shown in FIG. 12, the screen 46 includes multiple rectifying plates 47, each corresponding to one of the multiple through-holes 46a. The rectifying plates 47 are formed so that the flow direction of all the gas that enters the through-holes 46a from the outside of the cylinder configured by the screen 46 changes to a direction that follows the surface direction of the screen, or in other words, a swirling direction that follows the inner wall surface of the cylinder. Note that in Embodiment 2, the screen 46 is formed of a metallic material, and thus each rectifying plate 47 is obtained by shearing a portion of the location in which the through-hole 46a is formed and then causing plastic deformation to occur therein. In addition, the shape of the opening of the through-holes 46a may be circular, semicircular, rectangular, elliptical, semielliptical, and so on, and thus is not particularly limited.

Accordingly, as shown in FIG. 10, when heated air is supplied between the inner wall surface of the container 40 and the screen 46 via the second inlets 42a to 42c, the heated air swirls along to outside of the screen 46 along the inner wall surface of the container 40, and also passes through the screen 46, swirling within the cylinder configured thereby.

In addition, as shown in FIG. 9, the first inlet 41 is formed so that the fluid (including the pulverized material) discharged by the pulverizer 2 (see FIG. 7) is led into the cylinder configured by the screen 46 and that the fluid is supplied along the tangential direction of the cross section of this cylinder. Also, as shown in FIG. 11, the first outlet 43 is formed so as communicate with the interior of the cylinder configured by the screen 46, and is formed along the tangential direction of the cross-section of the cylinder (the tangential direction of the swirl flow 48). Therefore, the fluid introduced through the first inlet 41 also swirls within the cylinder configured by the screen 46.

Furthermore, as shown in FIG. 8, the first inlet 41 is provided near the raw material feed port 45. The first outlet 43 is provided near the second outlet 44 (in a location where the distance to the second outlet 44 is shorter than the distance to the first inlet 41). Therefore, when the pulverizer 2 is operated, the suction force thereof causes the fluid introduced into the container 40 through the first inlet 41 to flow from one side of the container 40 (in FIG. 8, the left side) to the opposite side (in FIG. 8, the right side) while swirling.

For this reason, the fluid introduced through the first inlet 41 combines with the heated air introduced through the second inlets 42a to 42c, and together forms the swirl flow 48 that advances from one side of the container 40 to the other while swirling along the inner wall surface of the cylinder configured of the screen 46. Therefore, in Embodiment 2, the raw material advances along the interior of the container while experiencing the swirling force of the swirl flow 48. Also, at this time, the raw material blooms out due to the swirl flow 48, in the same manner as in Embodiment 1. Furthermore, in the case where pulverized material is already loaded in the container 40, the pulverized material already loaded collides with raw material with a high moisture content loaded later, thereby advancing the drying, in the same manner as the example described in Embodiment 1.

The less sufficient the drying and pulverizing is for a pulverized material, the greater the centrifugal force thereon is, and thus such pulverized material passes through the first outlet 43 and is once again led to the pulverizer 2. However, pulverized material whose drying and pulverizing is sufficient is present in the vicinity of the center of the swirl flow 48, and thus passes through the second outlet 44 and is led to the collector 14 (see FIG. 1).

Note that in Embodiment 2, when a heavy raw material with a high moisture content is supplied to the interior of the container 40, the raw material cannot ride the swirl flow 48 near the raw material feed port 45, and thus flows in an area lower than the central axis of the container 40 while tracing an elliptical or semicircular trajectory 51, as shown in FIG. 9. However, this heavy material gradually blooms out and dries, becoming lighter, as a result of contact with the heated air. Thus, in the vicinity of the center of the container 40, the trajectory 51 of the raw material approaches a circular shape (see FIG. 10), and furthermore, becomes approximately circular in shape near the first outlet 43 (see FIG. 11).

As described thus far, in Embodiment 2, the pulverized material can be dried sufficiently without increasing the size of the drier, in the same manner as in Embodiment 1. In addition, in Embodiment 2, a better energy efficiency than with the conventional technology also can be realized. Furthermore, in Embodiment 2, the raw material to be pulverized and dried is also not particularly limited.

In Embodiment 2, the container for drying is placed on its side, and thus the direction in which the raw material, including the pulverized material, travels is the horizontal direction. For this reason, Embodiment 2 is suited to a case where a material whose moisture content is higher and whose mass is larger than the material used in Embodiment 1 is used.

In Embodiment 2, the container 40 is not limited to the example shown in FIGS. 7 through 12. For example, the screen 46 does not necessarily have to be in a cylindrical shape, and may instead be a plate whose cross-section is an arc. In addition, although the screen 46 is provided with multiple through-holes 46a across its entire length in Embodiment 2, the screen 46 is not limited to such a configuration. The configuration may be such that the through-holes 46a are provided only in part of the screen 46.

FIG. 13 is a cross-sectional view illustrating another example of the container that can be used in Embodiment 2. In the example of FIG. 13 as well, the screen 46 is not formed in a cylindrical shape, but is rather formed in a halfpipe shape. However, in the example of FIG. 13, the screen 46 has the cross-sectional structure illustrated in FIG. 11. In other words, the screen 46 is provided with through-holes 46a and rectifying plates 47 (see FIG. 12) corresponding thereto. Therefore, as shown in FIG. 13, the swirl flow 48 also is created in this case, where heated air is supplied toward the screen 46. In this manner, in Embodiment 2, the shape of the screen 46 is not particularly limited.

### Embodiment 3

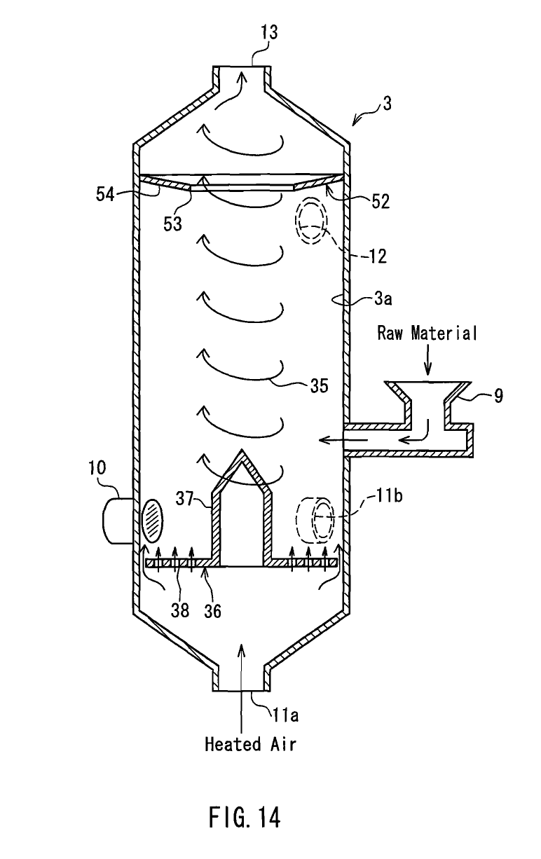

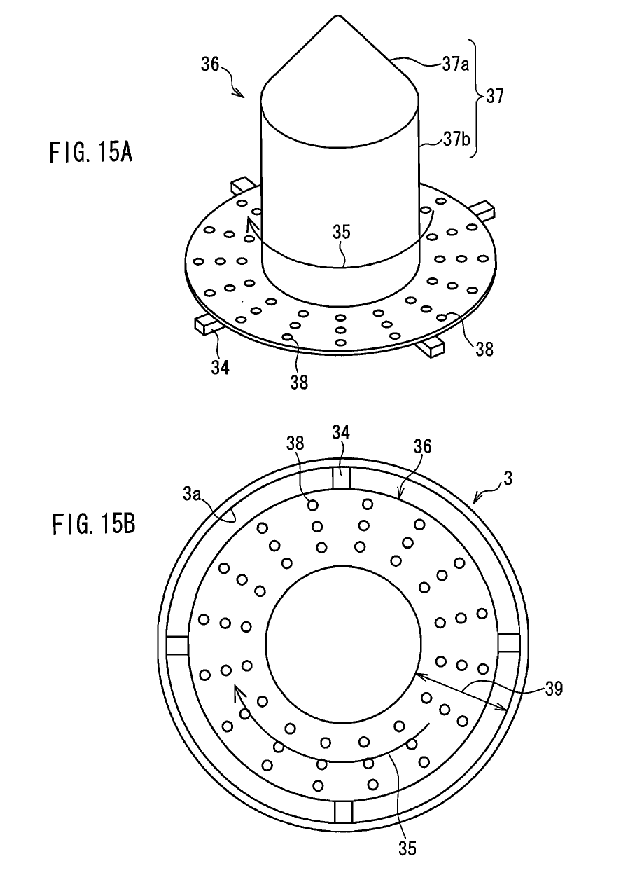

Hereinafter, a pulverized material producing system according to Embodiment 3 of the present invention shall be described with reference to FIGS. 14 and 15. FIG. 14 is a cross-sectional view illustrating the detailed configuration of a container used in the pulverized material producing system according to Embodiment 3 of the present invention. FIG. 15 includes diagrams illustrating a plate member shown in FIG. 14; FIG. 15A is a perspective view, and FIG. b) is a plan view.

As shown in FIG. 14, the pulverized material producing system of Embodiment 3 differs from the pulverized material producing system of Embodiment 1 in terms of the internal structure of a container 3. Aside from the internal structure of the container 3, however, the pulverized material producing system of Embodiment 3 has the same configuration as the pulverized material producing system of Embodiment 1. Like in Embodiment 1, the container 3 is placed vertically in Embodiment 3. Hereinafter, the differences therebetween shall be described in detail.

As shown in FIG. 14, a plate member 36 is disposed within the container 3. Like the plate member 30 of Embodiment 1 illustrated in FIG. 6, the plate member 36 is disposed above the second inlet 11a within the container 3 so as to cover the interior of the container 3.

However, in Embodiment 3, the plate member 36 differs from the plate member 30 in that a projection portion 37 that projects in the upward direction is provided in the central portion thereof, as shown in FIGS. 14 and 15A. The plate member 36 also is provided with multiple through-holes 38 in the area surrounding the projection portion 37.

The tip of the projection portion 37 has a conical shape, and the outline of the cross-section perpendicular to the direction in which it projects is formed in a circular shape. In the example shown in FIGS. 14 and 15, the projection portion 37 is configured of a conical-shaped portion (tip portion) 37a and a cylindrical portion (trunk portion) 37b. When the plate member 36 is disposed within the container 3, the projection portion 37 and the inner wall surface 3a of the container 3 form a circular flow channel 39, as shown in FIG. 15B.

Therefore, in Embodiment 3, the fluid introduced into the container through the first inlet 10 and the heated air introduced through the second inlets 11a and 11b combine, and first advance along the flow channel 39. As a result, according to Embodiment 3, the swirl flow 35 can be created more easily than in Embodiment 1. Due to the creation of the swirl flow 35, heavy pulverized material swirl near the inner wall surface 3a of the container 3, whereas light pulverized material swirl near the center of the container 3.

Furthermore, as described in Embodiment 1, the heavy raw material that cannot rise flows on top or near the top of the plate member 36 without rising in Embodiment 3 as well. Part of the heated air that has passed through the opening portions 38 collides with the heavy material that cannot rise, causing that material to bloom out and dry. Providing the plate member 36 makes it possible to realize an improvement in drying efficiency over the case where the plate member 36 is not provided. In addition, providing the plate member 36 prevents raw material from attaching to the corners of the container 3 due to some raw material coming into little contact with the heated air.

Like the plate member 30, the plate member 36 is installed using cross-shaped stays 34 (not shown in FIG. 14). The stays 34 are attached to the inner wall surface 3a. Also, the plate member 36 is formed so that a space exists between its outer edge and the inner wall surface 3a, so that raw material does not build up/become attached between the inner wall surface 3a of the container 3 and the upper surface of the plate member 36 when the plate member is installed.

In addition, in Embodiment 3, a circular member 52 furthermore is disposed along the inner wall surface 3a of the container 3 at a location between the second outlet 13 and the plate member 36 within the container 3, as shown in FIG. 14. The first outlet 12 is provided below the circular member 52.

In Embodiment 3, heavy pulverized material that swirls near the inner wall surface 3a of the container 3 cannot rise higher than the circular member 52, and thus efficiently is sent to the first outlet 12 while swirling in that area. However, light pulverized material passes through an opening portion 53 in the center of the circular member 52, and then is discharged to the exterior through the second outlet 13.

In this manner, according to the pulverized material producing system of Embodiment 3, pulverized material that has not reached the product stage can be transported reliably to the pulverizer, making it possible to improve the functionality for removing only the pulverized material that has reached the product stage (the classifying functionality). In the example of FIG. 14, the circular member 52 is formed in a funnel shape, and has a sloped surface 54 that descends in the downward direction toward the center. This is to make it easy for the pulverized material that has not reached the product stage to be led to the first outlet 12. Note that in Embodiment 3, the circular member 52 may have a shape that does not have the sloped surface 54, such as a circular plate member.

Additionally, in Embodiment 3, it is favorable for the speed of the heated air expelled from the through-holes 38 to be greater than or equal to 15 m/s, and particularly favorable for this speed to be 25 to 40 m/s. This increases the speed of the heated air in the upward direction (the upward air speed), making it easier for heavy raw material to rise. Furthermore, the projection portion 37 is not limited to the example shown in FIGS. 14 and 15, and may be formed of only the conical portion.

### Embodiment 4

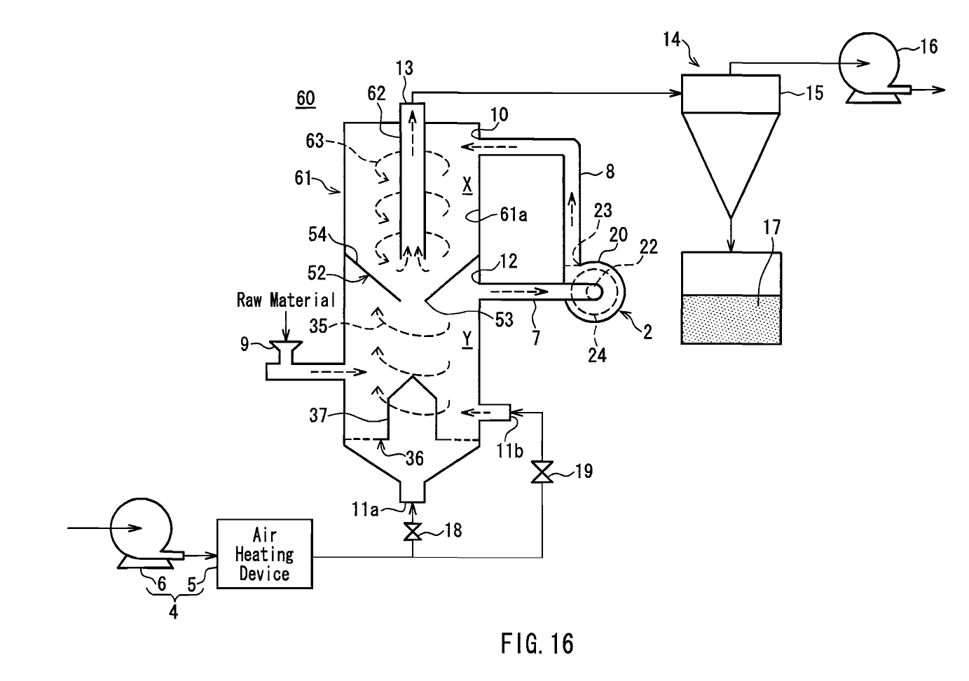

Hereinafter, a pulverized material producing system according to Embodiment 4 of the present invention shall be described with reference to FIG. 16. FIG. 16 is a structural diagram schematically illustrating the overall configuration of the pulverized material producing system according to Embodiment 4 of the present invention.

A pulverized material producing system 60 of Embodiment 4 differs from the pulverized material producing system 1 of Embodiment 1 in terms of the structure of a container 61 and the connecting structure between the container 61 and the pulverizer 2. Aside from that, however, the pulverized material producing system 60 of Embodiment 4 has the same configuration as the pulverized material producing system 1 of Embodiment 1. Detailed descriptions shall be given hereinafter.

As shown in FIG. 16, in Embodiment 4 as well, the container 61 has a cylindrical shape, and is placed vertically, as with the container 3 used in Embodiment 1. Furthermore, like the container 3, the second outlet 13 is provided in the portion of the container 61 that is the highest portion when the container is installed. The raw material used for producing the pulverized material is supplied directly to the interior of the container 61 by a raw material feeder 9, at a location near the bottom of the container.

Furthermore, the second inlets for supplying heated air are, as with the container 3, provided in two places, one at the portion of the container 61 that is lowermost when the container 61 is installed, and one in the side surface of the container 61 (the second inlets 11a and 11b). In addition, the container 61 has, like the container 3 used in Embodiment 3, a plate member 36 disposed in the lower area within the container 61, and a circular member 52 disposed thereabove.

However, while in the first and third embodiments, the first inlet 10 is provided below the first outlet 12, in Embodiment 4, the first inlet 10 is provided above the first outlet 12. In Embodiment 4, the first outlet 12 is provided between the plate member 36 and the circular member 52, as shown in FIG. 16. The first inlet 10 thus is provided above the first outlet 12 and between the second outlet 13 and the circular member 52.

In addition, a suction pipe 62 communicating with the second outlet 13 and extending downward is provided in the interior of the container 61. The end of the suction pipe 62 is set so that a space is created between itself and the opening portion 53 of the circular member 52. Note that the first inlet 10 and the first outlet 12 both are formed along the tangential direction of the cross-section of the container 61 (see FIGS. 4 and 5).

Here, inside the container 61, the space above the circular member 52 is taken as X, whereas the space below the circular member 52 is taken as Y. According to the configuration of the container 61, a swirl flow 35 that rises while swirling is created in the space Y by the heated air supplied through the second inlets 11a and 11b, like in the first and third embodiments. Thus, comparatively light raw material that is supplied rises due to the swirl flow 35, eventually passing to the pulverizer 2 via the first outlet 12.

On the other hand, a swirl flow 63 that descends while swirling is created in the space X by the circular flow channel formed in between the inner wall surface 61a of the container 61 and the outer surface of the suction pipe 62 and the first inlet 10 provided in the upper portion of the container 61. Of the pulverized material swirling due to the swirl flow 63, light pulverized material that has reached the product stage is drawn through the opening in the end of the suction pipe 62, and is discharged to the exterior via the second outlet 13. As opposed to this, the heavy pulverized material once again is sent to the space Y through the opening portion 53 of the circular member 52, and again is sent to the pulverizer 2 via the first outlet 12. According to Embodiment 4, pulverized material that has reached the product stage can be reliably removed, and the classifying functionality can be improved beyond that of the first through third embodiments.

Furthermore, with Embodiment 4, a descending air flow is created in the upper space X, resulting in a greater temperature difference between the space X and the space Y, whereby the temperature of the space Y becomes high. Therefore, raw material supplied through the raw material feeder 9 blooms out and is dried above the plate member 36, and is exposed to a higher temperature than in the first through third embodiments by the time it has become able to rise as far as the circular member 52.

For this reason, the pulverized material producing system of Embodiment 4 is particularly useful in cases where high-temperature processing needs to be carried out on the raw material, such as the case where a fresh raw material needs to be sterilized, the case where chemicals such as pesticides present on the raw material need to be separated therefrom using heat, and so on.

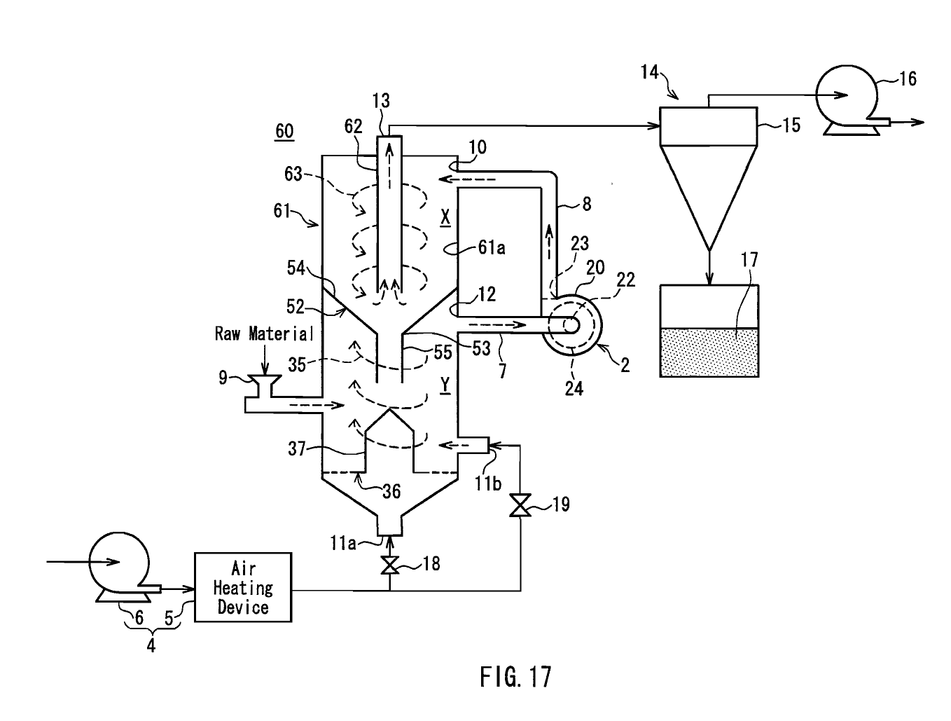

In addition, the pulverized material producing system of Embodiment 4 may be configured as shown in FIG. 17. FIG. 17 is a structural diagram schematically illustrating another example of the overall configuration of the pulverized material producing system according to Embodiment 4 of the present invention. In the example of FIG. 17, the opening portion 53 of the circular member 52 is provided with a nozzle 55 communicating with the opening portion 53 and extending downward therefrom. The nozzle 55 is formed so that its end is located above the projection portion of the plate member 36.

According to the example of FIG. 17, the swirling action of the swirl flow 35 within the space Y can be increased, making it possible to accelerate the mixing of raw material newly loaded through the raw material feeder 9 (raw material not yet sent to the pulverizer 2) with the pulverized material. To be more specific, this mixing, as discussed in Embodiment 1, allows more efficient drying to take place, as the collisions between the pulverized material and the newly-loaded raw material are accelerated further, thereby increasing the moisture migration between solids.

### Embodiment 5

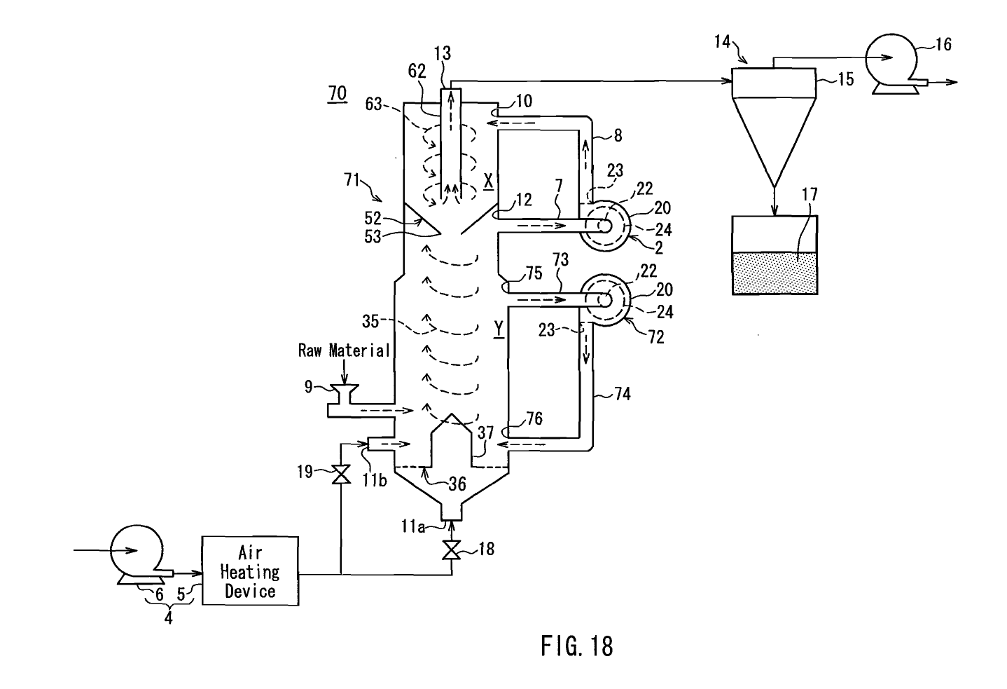

Hereinafter, a pulverized material producing system according to Embodiment 5 of the present invention shall be described with reference to FIG. 18. FIG. 18 is a structural diagram schematically illustrating the overall configuration of the pulverized material producing system according to Embodiment 5 of the present invention.

As shown in FIG. 18, in Embodiment 5, a container 71 is configured by adding a third inlet 76 and a third outlet 75 to the container 61 shown in FIG. 16 in corresponding locations in the space Y below the circular member 52. The third inlet 76 and the third outlet 75 communicate with the interior of the container 71.

A pulverized material producing system 70 of Embodiment 5 includes a pulverizer 72 in addition to the pulverizer 2. Like the pulverizer 2, the pulverizer 72 includes a screen 24 and a casing 20. A suction port 22 and a discharge port 23 are provided in the casing 20. The suction port 22 of the pulverizer 72 is connected to the third outlet 75 via a pipeline 73. The discharge port 23 of the pulverizer 72 is connected to the third inlet 76 via a pipeline 74.

Incidentally, the third outlet 75 is provided below the first outlet 12. In addition, the third inlet 76 is provided below the third outlet 75. To be more specific, the third inlet 76 is provided in the same location as the first inlet 10 of the container 3 as shown in FIG. 1, and in a location opposite the side surface of the projection portion 37 of the plate member 36 (see FIG. 15).

In addition, in Embodiment 5, the portion below the first outlet 12 of the container 71 has the same configuration as in the first and third embodiments. Therefore, a raw material can be pulverized efficiently in the same manner as in the first and third embodiments, even when only the pulverizer 72 and the heated air supplier 4 are operating.

However, in Embodiment 5, pulverized material that has been pulverized by the pulverizer 72 and has become sufficiently small then proceeds to the pulverizer 2. This pulverized material then is pulverized further by the pulverizer 2, and then circulates in the circuit configured by the space X and the pulverizer 2 until it is drawn into the suction pipe 62.

In this manner, the pulverized material producing system of Embodiment 5 goes through two stages of pulverizing, and thus Embodiment 5 produces a pulverized material that is finer than that produced in the first through fourth embodiments. The present fifth embodiment is useful in cases where the particle size of the pulverized material is to be made as small as possible.

Meanwhile, the size of the pores 24a of the screen 24 (see FIG. 2C) in the pulverizers 72 and 2 can be changed. For example, the pores 24a in the pulverizer 72 can be made larger than the pores 24a of the pulverizer 2. In this case, the amount of blown air in the pulverizer 72 can be increased. Note that aside from the abovementioned configuration, the pulverized material producing system of Embodiment 5 has the same configuration as the pulverized material producing systeme of the first and third embodiments.

In the above first and second embodiments, another pulverizer may be added as necessary between the container and the collector (in the example of FIG. 1, in the flow channel that connects the second outlet 13 with the collector 14) in order to more finely pulverize the pulverized material that is discharged from the container.

Finally, the first through fifth embodiments can also be configured so that a high-temperature vapor, an inert gas (such as nitrogen gas), or the like are supplied to the circuit, the interior of the container, and so on. Such a configuration makes it possible to suppress oxygen from coming into contact with the raw material (including the pulverized material) and causing oxidation. This also acts as a sterilization process for the case where bacteria is present in the raw material.

### INDUSTRIAL APPLICABILITY

The pulverized material producing system of the present invention is capable of producing a pulverized material having sufficiently dried a raw material, while at the same time suppressing production costs, even in the case where a material having a high moisture content and viscosity is used as the raw material. The pulverized material producing system of the present invention thus has industrial applicability.

1-11. (canceled)

12. A method for producing a dried powder from a raw material containing moisture using a powder producing system,
wherein the powder producing system comprises: a pulverizer having a pulverizing function and a blowing function; a container; and a heated air supplier that supplies heated air, and
a suction port and a discharge port of the pulverizer are connected respectively to a first outlet and an inlet of the container via pipelines, so that a circuit system through which a fluid is allowed to circulate is formed,
the method comprising:
introducing a heated air into the circuit system, and forming a circulating flow by the blowing function of the pulverizer and forming a swirl flow of the heated air within the container;
introducing the raw material containing moisture into the circuit system, and
creating a mixture of the raw material whose drying state has advanced within the circuit system and/or a pulverized material thereof;
circulating the mixture along with the circulating flow in the circuit system, and pulverizing and drying the mixture;
classifying the mixture using a difference in the centrifugal force that acts on the mixture by the swirling within the container in such a manner that a dried powder of a predetermined size that swirls on a center side within the container is collected from a second outlet, and the remaining mixture that swirls on an inner wall surface side of the container circulates in the circuit system from the first outlet; and
pulverizing and drying the remaining mixture repeatedly by circulating the remaining mixture in the circuit system.

13. The method for producing a dried powder according to claim 12, wherein the raw material containing moisture is a plant-derived raw material and/or an animal-derived raw material.

14. A powder producing system for use in the method for producing a dried powder according to claim 12, the system comprising:
a pulverizer having a function of pulverizing a raw material and a blowing function;
a container; and
a heated air supplier that supplies heated air into the container, wherein the container includes a first inlet, a second inlet, a first outlet, and a second outlet, each of which communicates with the interior of the container,
the heated air supplier supplies the air to the interior of the container via the second inlet,
the pulverizer draws the raw material along with a fluid through a suction port and discharges the pulverized raw material along with the fluid through a discharge port using the blowing function, and
the first inlet of the container is connected to the discharge port of the pulverizer via a pipeline, and the first outlet of the container is connected to the suction port of the pulverizer via a pipeline.

15. The powder producing system according to claim 14,
wherein the pulverizer includes a casing provided with a suction port and a discharge port, an impeller disposed within the casing, and a screen, and the impeller draws a fluid through the suction port and discharges the fluid through the discharge port.

16. The powder producing system according to claim 14,
wherein the container has a cylindrical shape, and is formed so as to be capable of being installed in a state in which the lengthwise direction of the cylinder is parallel to the vertical direction, and, when the container is installed in a state in which the lengthwise direction of the cylinder is parallel to the vertical direction,
the second outlet is provided above the first outlet,
the second inlet is provided so that the air flows from the bottom to the top within the container,
the first inlet is provided so that the fluid introduced into the container therefrom swirls along the inner wall surface of the container, and
the first outlet is provided along the tangential direction of the fluid that is swirling.

17. The powder producing system according to claim 16,
wherein a plate member is disposed within the container above the second inlet so as to cover the interior of the container, and
the plate member includes a main body member provided with an opening portion in its center and provided with a plurality of through-holes in the periphery of the opening portion, and a rectifying member that is disposed above the opening portion and that directs the air that has passed through the opening portion toward the inner wall surface of the container.

18. The powder producing system according to claim 16,
wherein a plate member is disposed within the container above the second inlet so as to cover the interior of the container,
the plate member includes a projection portion that is provided in its central portion and that projects in the upward direction, and a plurality of through-holes provided in the peripheral portion of the projection portion, and
the projection portion is formed so that its tip has a conical shape and the outline of the cross-section perpendicular to the direction in which it projects is formed in a circular shape.

19. The power producing system according to claim 18,
wherein the second outlet is provided in the uppermost portion of the container,
a circular member is provided along the inner wall surface of the container in a position between the second outlet and the plate member, and
the first outlet is provided below the circular member.

20. The powder producing system according to claim 19,
wherein the second outlet is provided in the uppermost portion of the container,
a suction pipe communicating with the second outlet and extending downward is provided in the interior of the container,
a circular member is provided along the inner wall surface of the container in a position between the second outlet and the plate member,
the first outlet is provided between the plate member and the circular member, and
the first inlet is provided above the first outlet and between the second outlet and the circular member.

21. The powder producing system according to claim 20, further comprising a second pulverizer in addition to the first pulverizer,
wherein the container further includes a third inlet and a third outlet below the circular member,
the third inlet of the container is connected to a discharge port of the second pulverizer via a pipeline, and the third outlet of the container is connected to a suction port of the second pulverizer via a pipeline,
the third outlet is provided below the first outlet, and
the third inlet is provided below the third outlet and in a position opposite the side surface of the projection portion of the plate member.

22. The powder producing system according to claim 14,
wherein the container has a cylindrical shape, and is formed so as to be capable of being installed in a state in which the lengthwise direction of the cylinder is parallel to the horizontal direction,
the raw material is supplied to the interior of the contained from a portion that is an end portion on one side of the container when the container is installed in a state in which the lengthwise direction of the cylinder is parallel to the horizontal direction,
the second outlet is provided in a position nearer to the central axis of the container than the first outlet,
the first inlet is provided so that the fluid introduced into the container therefrom swirls along the inner wall surface of the container, and
the first outlet is provided along the tangential direction of the fluid that is swirling.

23. The powder producing system according to claim 22,
wherein a second screen that includes a plurality of through-holes is disposed in the interior of the container so as to be opposite all or part of the inner wall surface of the container,
the second screen includes rectifying plates, one for each of the through-holes, that change the flow direction of the gas that passes through the through-holes to the direction that follows the surface direction of the second screen, and
the second inlet is formed in the side surface of the container so that the air is supplied between the inner wall surface of the container and the second screen.
